(19) United States
(12) Patent Application Publication
(10) Pub. No.: US 2023/0162166 A1
(43) Pub. Date: May 25, 2023

(54) AUTOMATIC COLLECTION OF USER-GENERATED AUDIOVISUAL ASSETS AND GENERATION OF NON-FUNGIBLE TOKEN ASSETS

(71) Applicant: Keaton Keller, Glendale, CA (US)

(72) Inventor: Keaton Keller, Glendale, CA (US)

(21) Appl. No.: 17/990,620

(22) Filed: Nov. 18, 2022

Related U.S. Application Data
(60) Provisional application No. 63/281,619, filed on Nov. 19, 2021.

(51) Int. Cl. G06Q 20/06; G06F 21/60; G06Q 20/02

(52) U.S. Cl. CPC G06Q 20/065; G06F 21/602; G06Q 20/02

(57) ABSTRACT

An automated NFT creation and monetization system includes a fingerprinting module configured to automatically capture user-generated content from a social media profile of a user, a mechanization module configured to generate one or more NFT assets associated with the captured user-generated content from the social media profile of the user, and a library module configured to store the captured user-generated content from the social media profile of the user and provide a history of one or more blockchain records indicating one or more transfers of ownership of the one or more NFT assets associated with the captured user-generated content.

### CROSS REFERENCE TO RELATED APPLICATION

This application claims the benefit of U.S. Provisional Application Ser. No. 63/281,619, filed Nov. 19, 2021, the entirety of which is incorporated by reference herein.

### BACKGROUND OF THE INVENTION

### Technical Field

Aspects of embodiments of the present disclosure relate to the field of automated collection, attribution, accreditation, and/or attestation of user-generated audio, visual, and/or audiovisual assets and the creation of non-fungible token assets associated with the user-generated audio, visual, and/or audiovisual assets.

### Description of Related Art

Many popular social media platforms and audio digital service providers, such as YouTube®, Instagram®, Spotify®, and TikTok®, allow users to upload audio, visual, still photographic, and audiovisual files that can be stored on the platform and viewed by other users. These original uploads may be referred to as first-party assets within the context of the present disclosure. Some platforms offer monetization for views or shares of first-party assets amongst users that provide content creators with revenue based on the popularity of their uploaded first-party assets. However, it is common for these first-party assets to be copied and distributed, or otherwise reproduced, by other users in an unauthorized fashion across multiple social media platforms. This prevents content creators from obtaining the full monetization potential of their first-party assets because views and shares of the unauthorized copies of their first-party assets decrease the views and shares directed to the original uploads. As such, while authorized first-party use of first-party assets may be monetized, monetization of third-party use remains difficult. This problem is, at least in part, driven by the fungibility of the first-party asset files, i.e., a copy of the upload is interchangeable with the original uploaded audiovisual file.

A Non-Fungible Token (NFT) is a unit of data recorded to a distributed digital ledger, often implemented as a blockchain, which can be sold and traded. NFTs can be associated with a particular digital or physical asset (such as a digital file), or a class of such assets, and a license to use the asset for a specified purpose. Ownership of an NFT (and the associated license to use, copy or display the underlying asset) can be traded and sold on digital markets.

### Problems that are to be Solved by the Invention

The widespread and unauthorized copying and distribution of original first-party assets uploaded to various social media platforms by content creators/artists denies the content creators/artists the opportunity of fully realizing the monetization potential of their creative works. Embodiments of the present disclosure are directed to the automatic collection of a user's first-party assets and the generation of NFT first-party assets that can be distributed and shared across partner social media platforms through verifiable transactions that can be monetized to compensate content creators/artists more accurately for views, shares, and other usage of their creative works.

### Means for Solving the Problem

Aspects of embodiments of the present disclosure may address issues of unauthorized copying and distribution of first-party assets by automatically collecting a user's first-party assets uploaded to various social media platforms and automatically generating NFT first-party assets that can be distributed on partner platforms through verifiable transactions with the third parties to allow for more accurate recording of views, shares, and other monetization/royalty-permissible uses of the NFT first-party asset enabling additional monetization revenue to be realized. Additionally, some embodiments of the present disclosure are directed to organizing and displaying a library of available NFT first-party assets that are associated with a user to facilitate transactions with other users and/or third parties.

### Effect of the Invention

Aspects of embodiments of the present disclosure are directed to providing content creators/artists with an integrated system that allows them to tokenize, store, and market NFT first-party assets based on their original user-generated content uploads to various social media platforms and audio digital service providers while also providing automated digital asset attestation, content-level accreditation, and monetization/tracking features to the content creators/artists through the use of smart contracts and other blockchain-agnostic asset management processes.

### SUMMARY OF THE INVENTION

One or more embodiments of the present disclosure may be directed to systems and methods of automating the collection of user-generated first-party assets, i.e., audio, visual, or audiovisual content, uploaded across various social media platforms and the tokenization of the user-generated first party assets that can be used to monetize/track usage of the tokenized assets across various social media platforms.

An automated NFT creation and monetization system, according to some aspects of embodiments of the present disclosure, includes a fingerprinting module configured to automatically capture user-generated content from a social media profile of a user, a mechanization module configured to generate one or more NFT assets associated with the captured user-generated content from the social media profile of the user, and a library module configured to store the captured user-generated content from the social media profile of the user and provide a history of one or more blockchain records indicating one or more transfers of ownership and one or more usage-metadata entries of the one or more NFT assets associated with the captured user-generated content.

The automated NFT creation and monetization system, according to some aspects of embodiments of the present disclosure, may have the library module further configured to record one or more monetization receipts associated with use of the user-generated content across one or more service providers.

The automated NFT creation and monetization system, according to some aspects of embodiments of the present disclosure, may have the mechanization module configured to generate one or more NFT third-party assets associated with one or more derivative works based on the captured user-generated content.

A user-generated digital asset tokenization and management platform system, according to some aspects of embodiments of the present disclosure, includes a fingerprinting module having a web crawler module configured to access and identify a user-generated content file hosted on a social-media account of a user, and an asset capture module configured to create a first party originating source file based on the user-generated content file. The user-generated digital asset tokenization and management platform system, according to some aspects of embodiments of the present disclosure, may further include a mechanization module having a smart contract module configured to generate a non-fungible token associating an ownership record configured to be stored in a blockchain with the first party originating source file, and a microtransaction module configured to pay and record fees associated with a token creation process on the blockchain. The user-generated digital asset tokenization and management platform system, according to some aspects of embodiments of the present disclosure, may also include a library module having an asset storage module configured to store, access, and manage the first party originating source file on a cloud storage network, an asset tracking module configured to manage digital rights management (DRM) products associated with the first party originating source file and the non-fungible token and track usage of the first party originating source file and the non-fungible token across a plurality of service providers, a monetization module configured to record and organize monetization receipts associated with the usage of the first party originating source file and the non-fungible token across the plurality of service providers, and a user profile module configured to produce a profile page describing the asset ownership and asset usage statistics associated with the user.

The user-generated digital asset tokenization and management platform system, according to some aspects of embodiments of the present disclosure, may have the fingerprinting module further include a verification module configured to verify that the user-generated content file was originally created by the user.

The user-generated digital asset tokenization and management platform system, according to some aspects of embodiments of the present disclosure, may have the web crawler module configured to repeatedly access the social media account of the user at a pre-determined intervals to identify newly added content.

The user-generated digital asset tokenization and management platform system, according to some aspects of embodiments of the present disclosure, may have the fingerprinting module further include a hashing module configured to create a unique hashed identifier for the first party originating source file based on the URL of the user-generated content file.

The user-generated digital asset tokenization and management platform system, according to some aspects of embodiments of the present disclosure, may have the fingerprinting module, the mechanization module, and the library module instantiated by the execution of a set of instructions by a processing unit of a host server network.

The user-generated digital asset tokenization and management platform system, according to some aspects of embodiments of the present disclosure, may have the smart contract module configured to generate the non-fungible token using a standardized token protocol.

The user-generated digital asset tokenization and management platform system, according to some aspects of embodiments of the present disclosure, may have the standardized token protocol use the ERC-721 token standard.

The user-generated digital asset tokenization and management platform system, according to some aspects of embodiments of the present disclosure, may have the standardized token protocol use the ERC-1155 token standard.

The user-generated digital asset tokenization and management platform system, according to some aspects of embodiments of the present disclosure, may have the mechanization module further include a watermark module to place a unique watermark within the first party originating source file.

The user-generated digital asset tokenization and management platform system, according to some aspects of embodiments of the present disclosure, may have the mechanization module configured to create a NFT third party asset associating a derivative work of the first party originating source file with a third-party ownership record configured to be stored on the blockchain.

A method for the automated collection of user-generated content and creation of associated NFT products, according to some aspects of embodiments of the present disclosure, includes the steps of identifying, by a web crawler module, a user-generated content file hosted on a social media profile of a user, copying, by a capture module, the user-generated content file to create a first party originating source file, associating, by a hashing module, a hashed identifier with the first party originating source file, wherein the hashed identifier is based on a query string parameter of a URL for the user-generated content file, storing, by a storage module, the first party originating source file within a cloud storage network, generating, by a smart contract module, a non-fungible token (NFT) first party asset for the first party originating source file by associating the first party originating source file and the user within a first block configured to be added to a blockchain, and displaying, by a library module, a first entry on a user profile corresponding to the NFT first party asset.

The method for the automated collection of user-generated content and creation of associated NFT products, according to some aspects of embodiments of the present disclosure, may include the step of verifying, by a verification module, that the user-generated content file was originally created by the user.

The method for the automated collection of user-generated content and creation of associated NFT products, according to some aspects of embodiments of the present disclosure, may also include the step of paying, by a microtransaction module, a fee associated with a token creation process.

The method for the automated collection of user-generated content and creation of associated NFT products, according to some aspects of embodiments of the present disclosure, may include the step of generating of the NFT first party asset by the smart contract module includes using one or more blockchain-agnostic standardized token protocols.

The method for the automated collection of user-generated content and creation of associated NFT products, according to some aspects of embodiments of the present disclosure, may also include the step of locating, by a wallet lookup module, a hashed wallet address associated with the user.

The method for the automated collection of user-generated content and creation of associated NFT products, according to some aspects of embodiments of the present disclosure, may have the fee associated with the token creation process be paid to verifiers on the blockchain.

The method for the automated collection of user-generated content and creation of associated NFT products, according to some aspects of embodiments of the present disclosure, may include the step of recording, by a monetization module, one or more monetization receipts from a service provider associated with usage of the first party originating source file.

### BRIEF DESCRIPTION

The features and advantages of embodiments of the present disclosure will become more apparent by reference to the following detailed description when considered in conjunction with the following drawings. In the drawings, like reference numerals are used throughout the figures to reference like features and components. The figures are not necessarily drawn to scale.

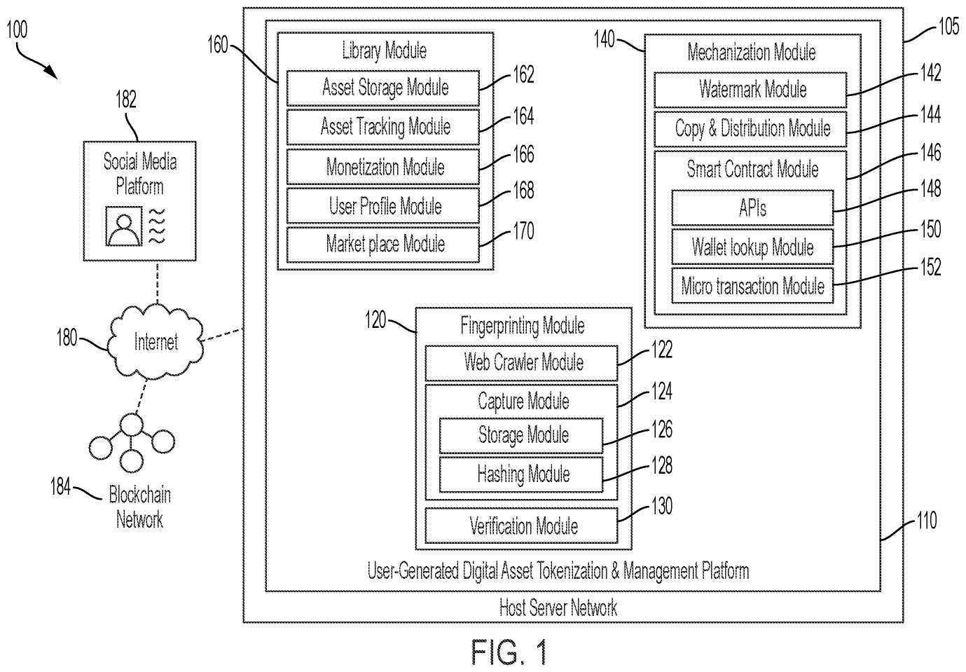

FIG. 1 is a diagram depicting a user-generated digital asset tokenization and management platform communicating via a network connection (Internet) with a blockchain network and a social media platform, according to some aspects of embodiments of the present disclosure;

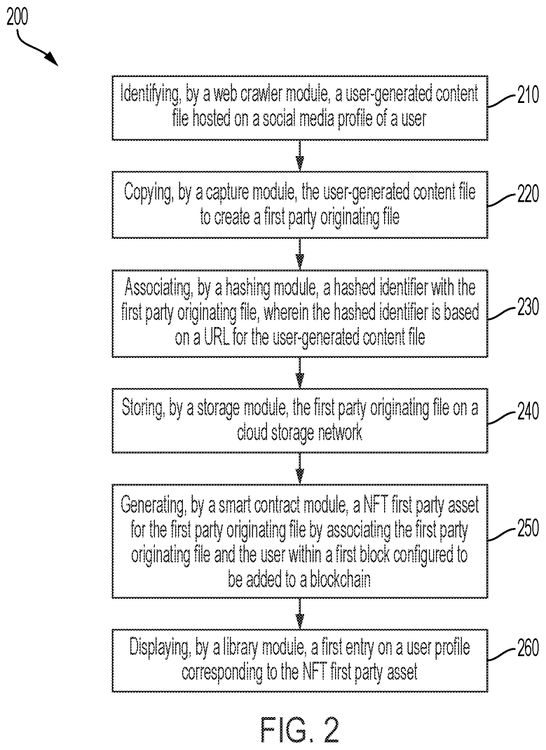

FIG. 2 is a flowchart depicting a method for the automated collection of user-generated content and creation of associated NFT products, according to some aspects of embodiments of the present disclosure; and

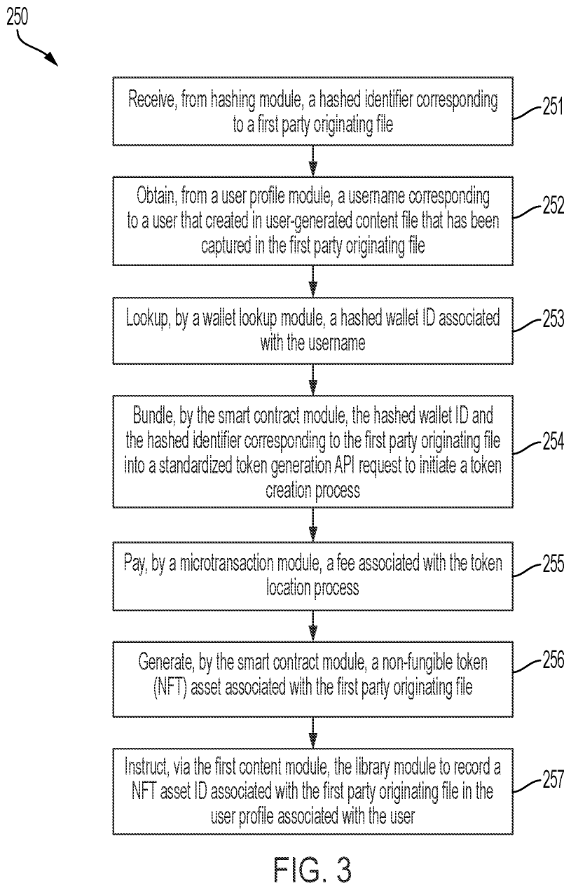

FIG. 3 is a flowchart depicting a method for generating, by a smart contract module, a NFT first party asset for a first party originating file by associating the first party originating file and a user within a first block configured to be added to a blockchain, according to some aspects of embodiments of the present disclosure.

### DETAILED DESCRIPTION

Features of the inventive concept and methods of accomplishing the same may be understood more readily by reference to the following detailed description of embodiments and the accompanying drawings. The inventive concept may, however, be embodied in many different forms and should not be construed as being limited to the embodiments set forth herein. Rather, these embodiments are provided as examples so that this disclosure will be thorough and complete, and will fully convey the aspects and features of the present invention to those skilled in the art. Accordingly, processes, elements, and techniques that are not necessary to those having ordinary skill in the art for a complete understanding of the aspects and features of the present invention may not be described. Unless otherwise noted, like reference numerals denote like elements throughout the attached drawings and the written description, and thus, descriptions thereof will not be repeated. In the drawings, the relative sizes of elements, layers, and regions may be exaggerated for clarity.

It will be understood that, although the terms “first,” “second,” “third,” etc., may be used herein to describe various elements, components, regions, layers and/or sections, these elements, components, regions, layers and/or sections should not be limited by these terms. These terms are used to distinguish one element, component, region, layer or section from another element, component, region, layer, or section. Thus, a first element, component, region, layer, or section described below could be termed a second element, component, region, layer, or section, without departing from the spirit and scope of the present invention.

Spatially relative terms, such as “beneath,” “below,” “lower,” “under,” “above,” “upper,” and the like, may be used herein for ease of explanation to describe one element or feature's relationship to another element(s) or feature(s) as illustrated in the figures. It will be understood that the spatially relative terms are intended to encompass different orientations of the device in use or in operation, in addition to the orientation depicted in the figures. For example, if the device in the figures is turned over, elements described as “below” or “beneath” or “under” other elements or features would then be oriented “above” the other elements or features. Thus, the example terms “below” and “under” can encompass both an orientation of above and below. The device may be otherwise oriented (e.g., rotated 90 degrees or at other orientations) and the spatially relative descriptors used herein should be interpreted accordingly.

It will be understood that when an element or layer is referred to as being “on,” “connected to,” or “coupled to” another element or layer, it can be directly on, connected to, or coupled to the other element or layer, or one or more intervening elements or layers may be present. In addition, it will also be understood that when an element or layer is referred to as being “between” two elements or layers, it can be the only element or layer between the two elements or layers, or one or more intervening elements or layers may also be present.

The terminology used herein is for the purpose of describing particular embodiments only and is not intended to be limiting of the present invention. As used herein, the singular forms “a,” “an,” and “the” are intended to include the plural forms as well, unless the context clearly indicates otherwise. It will be further understood that the terms “comprises,” “comprising,” “includes,” and “including,” when used in this specification, specify the presence of the stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Expressions such as “at least one of,” when preceding a list of elements, modify the entire list of elements and do not modify the individual elements of the list.

As used herein, the term “substantially,” “about,” and similar terms are used as terms of approximation and not as terms of degree, and are intended to account for the inherent deviations in measured or calculated values that would be recognized by those of ordinary skill in the art. Further, the use of “may” when describing embodiments of the present invention refers to “one or more embodiments of the present invention.” As used herein, the terms “use,” “using,” and “used” may be considered synonymous with the terms “utilize,” “utilizing,” and “utilized,” respectively. Also, the term “exemplary” is intended to refer to an example or illustration.

Unless otherwise defined, all terms (including technical and scientific terms) used herein have the same meaning as commonly understood by one of ordinary skill in the art to which the present invention belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

One or more embodiments according to the present disclosure will now be described. As described previously, aspects of the present disclosure are directed to systems and methods of automating the collection of user-generated first-party assets uploaded across various social media platforms and audio digital service providers (DSPs) and the generation of NFT assets based on the collected first-party assets. The collection of first party assets may be performed via any provably enabled method attestation of any Web2, Web3, or WebX asset as would be known by one skilled in the art to be suitable for the purpose of decentralized asset ownership and/or asset usage tracking. As used herein, the term “WebX” is intended to cover all future iterations of the Web. For simplicity, various social media platforms and audio digital service providers (DSPs) may be referred to herein collectively as “service providers.” A non-limiting embodiment of such a system, according to one or more aspects of embodiments of the present disclosure, is described in detail below.

FIG. 1 is a diagram depicting a digital asset tokenization and monetization system 100 communicating via a network connection (Internet) 180 with a blockchain network 184 and a social media platform 182, according to some aspects of embodiments of the present disclosure.

Social Media Platform

At the point of upload, to any social media platform or audio digital service provider (DSP) (i.e., TikTok®, YouTube®, Spotify®, Twitter®, etc.), depicted herein as a “social media platform 182,” a user generates a digital file or piece of content, referred to herein as a user-generated content file. This user-generated content file may comprise a digital audio, visual, and/or audiovisual file having any suitable file type. As described herein, this user-generated content file may also be referred to as a first-party asset or a social asset.

At the point of generation, i.e., on the social media platform 182, the user's user-generated content file may be displayed against his or her profile's wall, feed, or internal timeline. Typically, for most service providers, each piece of user-generated content posted/displayed on the platform in public, i.e., each user-generated content file, references a metadata signature as indicated within its associated URL. This metadata signature, a query string parameter ID sometimes referred to hereinafter as a “content file identifier” or more generally as a “query string parameter,” is presented in the URL associated with the original posting of the user-generated content file and can be used to uniquely identify the user-generated content file.

User-Generated Digital Asset Tokenization and Management Platform

The user-generated digital asset tokenization and management platform 110 may, in some embodiments, capture and automatically generate and record a non-fungible token (NFT) asset, also referred to herein as a NFT first party asset, associated with the user-generated content file hosted on the social media platform 182.

I. Fingerprinting Module

As depicted in FIG. 1, the user-generated digital asset tokenization and management platform 110 may, in some embodiments, include a fingerprinting module 120. The fingerprinting module 120 may, in some embodiments, be structured to include a plurality of additional component parts or modules. As depicted, in some embodiments, the fingerprinting module 120 may include a web crawler module 122.

After a user uploads his or her user-generated content file against a publicly, visible medium (i.e., the profile, post, or user is not private or hiding their social asset(s)), the web crawler module 122 of the fingerprinting module 120 may, in some embodiments, use social media account credentials entered by the user, that correspond to the user's social media profiles, to access and capture the uploaded user-generated content file and its corresponding content file identifier indicated on the URL corresponding to the original post. In some embodiments a user's social media account credentials may be prepopulated within the web crawler module 122 and not require manual entry by the user.

The web crawler module 122 may, in some embodiments, be set to automatically access a user's social media profiles and search for newly posted user-generated content at a predetermined frequency. In other embodiments, the fingerprinting module 120 may be prompted by the user to access the user's social media profiles and search for newly posted user-generated content. As will be appreciated by one skilled in the art, any algorithm or code for instantiating the web crawler module 122, or performing its operations, known to be suitable for this purpose may be used within the scope of the present disclosure.

In some other embodiments, the fingerprinting module 120 may include a verification module 130 to verify that the user's social media profile is the original source for a newly posted user-generated content file located by the web crawler module 122, i.e., that the newly posted user-generated content file is an original first-party asset of the user. As will be appreciated by one skilled in the art, the term “verification” as used herein may also encompass asset provenance verification and/or provenance attestation. As a non-limiting example, in some embodiments the verification module 130 may provide a provenance attestation during the verification process wherein the provenance attestation records the date the original content was posted, the URL where the original content was posted, and/or other metadata about the earliest known posting of the original content by the user. The verification module 130 may, in some embodiments, provide a prompt to the user to indicate if the user was the original author of the user-generated content file or to indicate if the user-generated content file is a derivative work based on an original work by another party. In some other embodiments, the verification module 130 may use one or more reverse image searches to locate any prior postings of the user-generated content file before verifying the user as the original author.

If the fingerprinting module 120 identifies, and in some embodiments verifies, a newly posted first-party asset of the user, then a capture module 124 may, in some embodiments, produce a copy or a duplicate file containing the first-party asset. In some embodiments, this may be an exact or 1:1 copy of the originally posted user-generated content file. In still other embodiments, the capture module 124 may copy only a query string parameter associated with the URL of the originally posted user-generated content or copy a parameter from a Uniform Resource Identifier (URI) associated with the originally posted user-generated content. For convenience, the embodiments of the present disclosure may include only descriptions of modules or processes that involve query string parameters of a URL associated with a user-generated content file or post, but the disclosures are intended also to cover all similar uses of URIs, and parameters associated with URIs.

The copied, or otherwise “captured,” user-generated content file may be referred to herein as a “first party originating file” or “first party originating source file.” The copied query string parameter may be referred to herein as a “first party source file origin” or as an “attestation record of a first party source file origin.” For simplicity, the present disclosure may refer herein only to capture, storage, and other processes/steps/locations involving “first party originating files” or “first party originating source files,” but the disclosures herein are to be construed as also describing the same processes/steps/locations for “first party source file origins” or “attestation records of a first party source file origin” unless otherwise specified. The first party originating source files may be stored for future use, in some embodiments, to a cloud storage network by a storage module 126 of the fingerprinting module 120. As will be appreciated by one skilled in the art, any suitable configuration of hardware, like solid-state drives (SSDs) and hard drives (HDDs) may be used for the cloud storage network within the scope of the present disclosure. Likewise, any suitable code or algorithm for the management of data transfers into and out of the cloud storage network by the storage module 126 may be used by the storage module 126 within the scope of the present disclosure. In some other embodiments, a “storage-less” configuration may be used wherein copies of the first party originating source files or the first party source file origins are not stored by the storage module 126, but the storage module 126 may be configured to store and recover first party source file origins from one or more records stored on a blockchain network 184, i.e., one or more metadata entries for a tokenized asset.

Additionally, in some embodiments, a unique hashed identifier associated with the first party originating source file may be generated by a hashing module 128 of the fingerprinting module 120. In some embodiments, the hashed identifier may be based on of the content identifier taken from the URL associated with the user-generated content file posting on the social media platform 182. In some other embodiments, if the content identifier includes a sufficiently large number of characters, then the content identifier may be used as the hashed identifier by the hashing module 128. As will be appreciated by one skilled in the art, the use of the term “unique hashed identifier” is intended to encompass any hashed strings of characters that may be suitable for the purpose of identifying a digital asset and may be synonymous with terms such as “token ID” and “asset ID.”

II. Mechanization Module

Once a first party originating source file has been captured, in some embodiments, one or more copies of the first-party asset are mechanized, i.e., converted into a NFT asset, by a mechanization module 140. As described above for the fingerprinting module 120, the mechanization module 140 may, in some embodiments, be made up of several component modules. As depicted in FIG. 1, in some embodiments, the mechanization module 140 may include a watermark module 142, a copy & distribution module 144, and a smart contract module 146. Each of these component modules is described in further detail below.

In some embodiments, a watermark module 142 may be used to place a watermark within a first party originating source file. The watermark may, in some embodiments, be a small icon or visual overlay integrated into the first party originating source file. For first party originating source files that include audio, the watermark may, in some embodiments, include a brief auditory note or signature that can be integrated into the captured audio. In some embodiments, the user may be able to preselect a watermark to be added to all of his or her captured first party originating source files. As a non-limiting example, a user could select to have a brand name or other signature added to increase the marketability of the content. In some other embodiments, the watermark module 142 may be configured to produce a digital signature stored as a metadata entry within the blockchain record of a tokenized NFT asset.

The generation of non-fungible tokens, i.e., NFT assets, associated with the captured first party originating source files may, in some embodiments, be executed by a smart contract module 146. The smart contract module 146 may, in some embodiments, be embodied, in part, as a distributed state machine to receive input data corresponding to the first party originating source file, i.e., the hashed identifier for the first party originating source file, and a user, i.e., a hashed wallet ID associated with the user, to generate tokens (NFT assets) embodied as records stored within blocks of a blockchain network 184.

As will be understood by one skilled in the art, any suitable smart contract and blockchain implementation may be used by the mechanization module 140 within the scope of the present disclosure. Use of or interfacing with both permissionless and permissioned, or otherwise private, blockchain implementations by the mechanization module 140 is thus encompassed within the scope of the present disclosure. Likewise, the use of or interfacing with different blockchain implementations offering varying degrees of transparency in both the coding of the blockchain protocol and the reviewability of data recorded to the blockchain are also within the scope of the present disclosure.

As such, although reference may be made throughout the present disclosure to various smart contracts, state machines, and/or blockchain implementations, the present disclosure is intended to be blockchain agnostic unless otherwise specified. Likewise, the use of standardized methods or operations for creating an NFT asset are intended to be blockchain agnostic unless otherwise specified. For simplicity, as depicted in FIG. 1, the application programming interface (API) method calls used within the smart contract module 146 to interface with a blockchain network 184 for the generation of tokens may be described herein as an API module 148 (otherwise referred to herein as “APIs 148”). In some embodiments, the API module 148 may be configured to incorporate standardized method calls regarding the creation and transfer of tokens, such as but not limited to ERC-20, ERC-721 and ERC-721a, ERC-777, ERC-4628, or ERC-1155 tokens. However, as will be appreciated by one skilled in the art, while the method calls for generating a token on different blockchain networks may vary and different types of tokens may be generated by using different standardized method calls within the same blockchain, all blockchain networks/implementations and the associated method calls for producing/transferring tokens on them may be used within the scope of the present disclosure.

As a non-limiting example, blockchain implementations such as Ethereum and Polygon may be used as the blockchain network 184 in some embodiments. However, the present disclosure is, unless other specified, blockchain agnostic and the disclosures provided herein are intended to be applicable to any suitable blockchain implementations as would be known to one skilled in the art. Likewise, in some embodiments, more than one blockchain implementation may be used by the user-generated digital asset tokenization and management platform 110, and as such, the blockchain network 184 as depicted in FIG. 1 may be representative of a plurality of different blockchain implementations.

Similarly, as will be understood by one skilled in the art, various different aspects of the blockchain implementation associated with the digital asset tokenization and monetization system 100, such as various different consensus mechanisms, may be utilized within the scope of the present disclosure. As a non-limiting example, some embodiments may include or otherwise interface with a blockchain implementation using a Proof-of-Work consensus mechanism. Likewise, as will also be appreciated by one skilled in the art, the compensation provided to blockchain network participants (operators/verifiers/validators/stakers/etc.) that successfully add blocks to the blockchain to record the creation or transfer of a token may be varied according to various factors such as, but not limited to, block size, average time to add a block, and transaction volume within the scope of the present disclosure.

In some embodiments, a Proof-of-Stake consensus mechanism may be utilized such that users may be permitted to stake their platform assets (once verified) to earn yield, while providing the blockchain's node operators (the Proof-of-Stake consensus) liquidity from each non-fungible asset. In some embodiments, user's may also be able to stake currency rather than NFT assets and receive, in some embodiments, different yield rates for staking currency rather than NFT assets.

The smart contract module 140 may, in some embodiments, include a wallet lookup module 150 to locate the hashed wallet ID associated with a user through user profile searchability via a specific asset, wallet, or user hashed ID. As will be appreciated by one skilled in the art, NFT assets are generated as a record containing various metadata entries within a block to be stored on a blockchain. One such piece of metadata may, in some embodiments, be the owner, i.e., the hashed wallet ID or hashed asset ID recorded as the original owner of the NFT asset. In some embodiments, the smart contract module 140 may use a wallet lookup module 150 to automatically locate a stored hashed wallet ID associated with the user for the purpose of listing the user as the owner of the generated NFT asset.

The generation of a token on a blockchain network 184 may, in some embodiments, be a process (token generation process) that requires a fee to be paid for the clock cycles expended by the blockchain network 184 in processing requests associated with the generation of the token or to compensate verifiers/miners/stakers competing or otherwise participating in the consensus mechanism of the blockchain network 184 to verify and add blocks containing records of NFT ownership/transfer/usage to the blockchain. In some embodiments, the smart contract module 140 may include a microtransaction module 152 (also referred to hereinafter as a “micro transaction module 152”) to record and pay such fees. As will be appreciated by one skilled in the art, the microtransaction module 152 may utilize any structure and connection to one or more bank accounts to record and pay the token generation fees. In some embodiments, the bank account utilized by the microtransaction module 152 may be a user's bank account. In some other embodiments, the bank account may be associated with the user-generated digital asset tokenization and management platform 110. In still other embodiments, the microtransaction module 152 may be further configured to allow for payments to an associated bank account.

Derivative works based on a first party originating source file may be produced by a third party, and, in some embodiments, uniquely associated with additional entries in the blockchain to create NFT third-party assets. In some embodiments, the management of the creation and storage/tracking of NFT third-party assets may be executed by a copy & distribution module 144. As will be understood by one skilled in the art, in some embodiments, the process described above for the creation of a NFT first-party asset may be similarly utilized in the creation of NFT third-party assets, but with additional metadata added to the blockchain records by the copy & distribution module 144 to link original authorship back to the user.

In some embodiments, the mechanization of the first party originating source file to create a NFT first-party asset and, if desired, one or more NFT third-party assets may be performed by the mechanization module 140 automatically or at the direction of a user. In some embodiments, NFT third-party assets may be automatically created when the first party originating source file is mechanized if derivative works based on the user-generated content file are located during verification. In some other embodiments, NFT third-party assets may be created by the copy & distribution module 144 on an as-needed basis as requests for such assets are received from the user or an authorized third party.

Various additional metadata associated with the NFT first-party asset and any NFT third-party assets, including ownership and third-party usage of an NFT asset, may be recorded within an entry or notation of the blockchain at the time of creation of the assets. In some embodiments, the mechanized assets, i.e., NFT first party assets and NFT third party assets, may be referred to as creator tokens, social equity tokens, or various other types of tokens as would be known to one skilled in the art. Similarly, as will be understood by one skilled in the art, any suitable standard for tokens, i.e., NFT assets, may be used within the scope of the present disclosure. This may include, but is not limited to, ERC-721 and ERC-1155 tokens or any of the other token standards named above on the Ethereum blockchain network.

Additional detail regarding the mechanization process is provided below in regard to FIG. 3.

III. Library Module

As depicted in FIG. 1, a library module 160, sometimes referred to as a vault module 160, may, in some embodiments, organize and display information regarding NFT first-party assets and third-party usage of a user's NFT first-party assets as well as any NFT third-party assets and usage associated with the user. As will be appreciated by one skilled in the art, the library module 160 may include one or more component modules. As depicted, the library module 160 may include an asset storage module 162, an asset tracking module 164, a monetization module 166, a user profile module 168, and a marketplace module 170, in some embodiments.

The library module 160 may, in some embodiments, handle the storage and organization of first party originating source files, user profiles and records of NFT ownership and/or usage, monetization receipts received from various service providers, and requests from third parties for use/purchase of NFT assets. In some other embodiments, referred to “storage-less” embodiments, the library module 160 may be configured to work with the storage module 126 of the fingerprinting module 120 to omit the storage of copies of first party originating files or first party source file origins and instead store/access only the first party source file origin associated with a user-generated content file as recorded in the metadata entries of one or more tokenized NFT assets.

In some embodiments, the storage and organization of first party originating source files may be handled by an asset storage module 162. The NFT assets (first party or third party) associated with a first party originating source file are stored as records in blocks on a blockchain network 184, but the underlying first party originating source file and other data relating to it may be stored/tokenized within the user-generated digital asset tokenization and management platform 110 on a cloud storage network managed by the asset storage module 162. As will be appreciated by one skilled in the art, any suitable database structure and associated code may be used to embody the asset storage module 162. In some embodiments, the asset storage module 162 may operate as a relational database. In some other embodiments, referred to “storage-less” embodiments, the asset storage module 162 may be configured to omit the storage of copies of first party originating files or first party source file origins and instead store/access only the first party source file origin as recorded in the metadata entries of one or more tokenized NFT assets.

In some other embodiments, an asset tracking module 164 may keep an internal record of the ownership/transactions/usage of an NFT first party asset or an NFT third party asset. A persistent record of this information is kept within the blockchain network 184 that stores the token associated with the NFT assets, but the asset tracking module 164 may periodically record and provide a user or a third party with a summary of the ownership and transactions/usage associated with an NFT asset of the user. As will be appreciated by one skilled in the art, any suitable algorithm for the periodic recording and summarization of ownership/transfer/usage updates to an NFT asset may be utilized by the asset tracking module 164 within the scope of the present disclosure. This may include, but is not limited to, keeping a chronological record displaying all of the relevant metadata taken from the most recently added block containing a record associated with the NFT asset on the blockchain network 184. In some other embodiments, the asset tracking module 164 may be configured to interface with the smart contract module 146 to update usage-metadata entries within records associated with an NFT asset and/or create new tokenized NFT assets to record usage-metadata entries on the blockchain network 184.

In some other embodiments, the asset tracking module 164 may be configured to receive usage reports for unauthorized use of a user's NFT assets from one or more service providers and be further configured to facilitate automated reporting or other programmatic enforcement processes to identify, report, and/or stop unauthorized use of a user's NFT assets.

The library module 160 may, in some embodiments, include a monetization module 166 to handle the tracking and recording of usage/monetization/provenance receipts received from third party service providers i.e., third party WebX platforms. Various usage/monetization metrics associated with the first-party and third-party NFT assets may be tracked/displayed by the monetization module 166. For NFT first-party assets, these metrics may include, but are not limited to, source-platform continuous view count, and number of followers, subscribers, or fans “watching” the user's profile. Similarly, for NFT third-party assets, the displayed metrics may include, but are not limited to: breakdown of Top 100 usage instances (by asset ID—clickable, then showcasing the 3rd party user's profile(s)); per-platform continuous view count; and number of followers, subscribers, or fans “watching” or otherwise viewing the third-party user's profile. In most instances, these metrics will be associated with a monetization receipt from one or more service providers to record the compensation due to the user for the distribution of his or her user-generated content file and/or NFT assets. In some embodiments, the monetization module 166 may store such monetization receipts and associate them with the user.

As described herein, there may, in some embodiments, be a significant amount of information about a user and his or her first party originating source files and NFT assets that may be utilized by the user-generated digital asset tokenization and management platform 110. As such, in some embodiments, the library module 160 may include a user profile module 168 to provide a simplified interface for locating and reviewing/modifying user data. In some embodiments, where one or more component modules of the library module 160 function as a relational database, the user profile module 168 may keep user information stored in a profile record that can be associated with one or more records in another module's relational database structure. However, as will be appreciated by one skilled in the art, any suitable structure and/or coding for the user profile module 168 may be used within the scope of the present disclosure.

First party originating source files and/or NFT assets associated with a user may, in some embodiments, be made public, so that other parties wishing to conduct transactions with the NFT first-party assets or the NFT third-party assets, or to request licenses for the use of these assets, can view them and purchase copies and/or licenses regarding the assets. In some embodiments, the public display and handling of transactions or requests by third parties may be executed by a marketplace module 170. The marketplace module 170 may, in some embodiments, provide a public and verifiable ownership model for the NFT first-party assets and NFT third-party assets across partner platforms. As will be appreciated by one skilled in the art, any suitable structure and/or coding as would be known by one skilled in the art to be suitable for marketing and/or e-commerce performed by the marketplace module 170 may be used within the scope of the present disclosure.

Assets associated with a user may, in some embodiments, be stored locally or across multiple cloud-based servers (cloud storage network), and publicly viewable changes to the originally captured user-generated content file may be tracked, recorded, and displayed within the library module 160 as new first party originating source files are created following the changes to the underlying user-generated content file. In such embodiments, the library module 160 may work in connection with the fingerprinting module 120 and the mechanization module 140 to keep an automated production of NFT assets ongoing for a user.

In some embodiments, items, such as NFT assets, listed in a user's profile may incorporate various digital rights management (DRM) technologies provided by one or more DRM platform providers. By coordinating with DRM providers across various social media platforms 182, usage of the NFT first-party assets and NFT third-party assets may, in some embodiments, be monitored/tracked and a monetization claim for use on the various social media platforms may be generated and managed by the monetization module 166. This may, in some embodiments, allow a content creator/artist to monetize not only the views/shares associated with the NFT first-party asset, but also to market for sale NFT third-party assets based on the original NFT first-party asset and generate monetization claims for use of the transactable NFT third-party assets across multiple social media platforms within the library module 160.

In some embodiments, monetization from third-party usage of a NFT first-party asset or NFT third-party asset may include the creation of third-party profiles within the library module 160 and coordination with various native and foreign DRM providers by the monetization module 166. For example, in some embodiments, a third party using a NFT first-party asset may cause a signal to be sent to the library module 160. In some embodiments, this signal may be produced and sent by a DRM provider or partner platform, such as social media platform 182. In some other embodiments, a surveillance module (not depicted), may provide monitoring across various partner platforms for third-party usage of NFT first-party or NFT third-party assets associated with a user. The signal may contain information describing the third party's use and an account or profile associated with the third-party usage. Upon receipt of a signal, in some embodiments, the library module 160 may then store the monetization signal via the monetization module 166 and then provide input to the smart contract module 146, of the mechanization module 140, to create a record associated with the NFT first-party asset in a new block to be added to the blockchain of the blockchain network 184 describing the third-party usage of the NFT first-party asset. In some instances, a new user profile may be generated for the third party by the user profile module 168 based on information received in the signal that may be further used to track usage of the NFT first-party asset by that third party, and information about the third party may be made available for public view by the library module 160. As will be understood by one skilled in the art, a similar process may be employed for tracking and recording third-party usage of a NFT third-party asset associated with a user.

When the third party's usage may be transformative, a new third-party originating source file may be captured along with an associated hash identifier for the transformed asset, i.e., the derivative work based on the first party asset, and a new NFT third party asset may be produced according to the process described above that can be associated with both the third party and the user, i.e., NFT first-party asset owner, whose asset was transformed. Usage of the newly generated NFT asset may then be tracked and recorded as previously described in regard to usage of an NFT first-party asset.

Monetization claims for third-party usage of NFT first-party assets and NFT third-party assets may, in some embodiments, be prepared in cooperation with various partner platforms, such as but not limited to social media platform 182. In this way, a more accurate “value” for an asset may be determined according to its use, and possibly advertising associated with its use, across one or more partner platforms. The partner platforms may include, but are not limited to, digital service providers such as YouTube®, Spotify®, and Apple Music®.

Thus, according to some aspects of embodiments of the present disclosure, the user-generated digital asset tokenization and management platform 110 may integrate content creation with an automated tokenization and management system that may assist content creators/artists more fully realize the monetization potential of their works. As a non-limiting example, some embodiments of the present disclosure may, upon the creation of a user-generated content file (otherwise referred to hereinafter as a “social asset”) on a WebX social media platform, like social media platform 182, begin the process of recording and verifying the social asset's provenance, origin, and other various metadata via the fingerprinting module 120. The mechanization module 140 may then tokenize the social asset and thereby create a NFT first party asset that can be marketed for licensing and/or sale on the user-generated digital asset tokenization and management platform 110 via the marketplace module 170. As a non-limiting example of the license types that may be offered on the marketplace, a user could offer fan licenses, third party re-use licenses, and collateralized asset royalty license as would be known to one skilled in the art. Through the marketplace module 170, license fees and royalties can thus be produced for the user. Moreover, via the asset tracking module 164, in some embodiments, third party usage can be monitored, tracked, and monetized. In such embodiments, the monetization module 166 may collect asset royalties and revenue reports and provide payouts to the user.

Method for the Automated Collection of User-Generated Content and Creation of Associated NFT Products

Turning now to FIG. 2, a flowchart describing a non-limiting embodiment of a method for the automated collection of user-generated content and creation of associated NFT products 200 (hereinafter “method 200”) is shown, according to one or more aspects of embodiments of the present disclosure.

As depicted, in some embodiments, the method 200 may begin at step 210 by identifying, by a web crawler module 122 (as seen in FIG. 1), a user-generated content file hosted on a social media profile of a user. After identification of the user-generated content file, the method 200 may proceed to step 220 copying, by a capture module 124 (as seen in FIG. 1), the user-generated content file to create a first party originating source file. The first party originating source file may then, in some embodiments, at step 230 be associated, by a hashing module 128 (as seen in FIG. 1), with a hashed identifier. In some embodiments, the hashed identifier may be based on a content identifier taken from the URL associated with the user-generated content file. Afterward, the method 200 may, in some embodiments, proceed to step 240 storing, by a storage module 126 (as seen in FIG. 1), the first party originating source file and its hashed identifier on a cloud storage network. The step of storing the first party originating source files, i.e., step 240, may, in some embodiments (“storage-less” embodiments) be omitted as described above.

Mechanization of the first party originating source file may then begin, and the method 200 may, in some embodiments, proceed to step 250 generating, by a smart contract module 146 (as seen in FIG. 1), an NFT first party asset based on the first party originating source file by associating the first party originating source file and its hashed identifier with a user within a record to be stored in a block recorded on a blockchain of a blockchain network 184 (as seen in FIG. 1).

Once the NFT first party asset has been generated, the method 200 may, in some embodiments, proceed to step 260 displaying, by a library module 160 (as seen in FIG. 1), a first entry corresponding to the NFT first party asset on a user profile corresponding to the user.

As will be appreciated by one skilled in the art, embodiments of the above-described method 200 may omit one or more of the above-described steps, or the above-described steps may, in some embodiments, be performed in a different order than the order described above.

Method for Mechanization of a First Party Originating Source File

Moving to FIG. 3, a flowchart depicting of the mechanization process, i.e., step 250 of method 200, from the perspective of the mechanization module is shown, according to one or more aspects of embodiments of the present disclosure.

As shown, step 251 may, in some embodiments, be receiving, from a hashing module 128 (as seen in FIG. 1) of the fingerprinting module 120 (as seen in FIG. 1), a hashed identifier corresponding to a first party originating source file.

Then, at the step 252, the mechanization module 140 (as seen in FIG. 1) may, in some embodiments, obtain from a user profile module 168 (as seen in FIG. 1), a username corresponding to a user that created a user-generated content file that has been captured and made into a first party originating source file.

At step 253, in some embodiments, the mechanization module 140 (as seen in FIG. 1) may, in some embodiments, look up, by the wallet lookup module 150 (as seen in FIG. 1), a hashed wallet ID associated with the username. In some other embodiments, the wallet lookup module 150 (as seen in FIG. 1) may look up a user via a hashed asset ID or any other ID associated with the user.

Next, at step 254, the mechanization module 140 (as seen in FIG. 1) may, in some embodiments, bundle, via the smart contract module 146 (as seen in FIG. 1), the hashed wallet ID and the hashed identifier associated with the first party originating source file into a standardized token generation API request (method call) to initiate a token creation process on a blockchain network 184 (as seen in FIG. 1).

Proceeding to step 255, the mechanization module 140 (as seen in FIG. 1) may, in some embodiments, pay, using the microtransaction module 152 (as seen in FIG. 1), a fee associated with the token creation process.

Subsequently, at step 256, the smart contract module 146 (as seen in FIG. 1) may, in some embodiments, generate a NFT first party asset (token) associated with the first party originating source file that records ownership of the asset on the blockchain of the blockchain network 184 (as seen in FIG. 1).

Finally, at step 257, the mechanization module 140 (as seen in FIG. 1) may, in some embodiments, instruct the library module 160 (as seen in FIG. 1) to record a NFT asset ID associated with the first party originating source file within the user profile corresponding to the user.

As will be appreciated by one skilled in the art, embodiments of the above-described mechanization process 250 may omit one or more of the above-described steps, or the above-described steps may, in some embodiments, be performed in a different order than the order described above.

Implementation of the Systems and Methods Described Herein on a Special-Purpose Computing Network

As will be appreciated by one skilled in the art, the systems and methods described in the present disclosure may be embodied or implemented by software modules instantiated by the execution, performed by one or more processing units, of instructions stored as programming code on a memory or storage of a specialized computing device or network of computing devices, such as a host server network 105. In some embodiments, a host server network 105 when programmed as described herein, may operate as a specially programmed computer capable of implementing one or more methods, apparatus and/or systems of the embodiments described in the present disclosure. In some embodiments, the host server network 105 may include one or more processing units that may be coupled to a bi-directional communication infrastructure such as a communication infrastructure system bus. The communication system bus may generally be a system bus that provides an interface to the other components in one or more computing devices included within the host server network 105 such as a main memory, a display interface, a secondary memory, and/or a communication interface.

The main memory may, in some embodiments, provide a computer readable medium for accessing and executing stored data and applications. The display interface may, in some embodiments, communicate with a display unit that may be utilized to display outputs to the user of the specially-programmed computer system, i.e., the host server network 105. The display unit may, in some embodiments, include one or more monitors that may visually depict aspects of the software modules of the present disclosure to the user. The main memory and the display interface may, in some embodiments, be coupled to the communication infrastructure, which, in some embodiments, may serve as the interface point to a secondary memory and the communication interface. The secondary memory may, in some embodiments, provide additional memory resources beyond the main memory, and may generally function as a storage location for programming instructions to be executed by the one or more processing units of the host server network 105. Either fixed or removable computer-readable media may serve as the secondary memory. The secondary memory may include, for example, hard disks (HDDs) and removable storage drives that may have an associated removable storage unit. There may be multiple sources of secondary memory and host server networks 105 or other computing devices implementing the software module embodiments described in the present disclosure may be configured as needed to support the data storage requirements of the user and the methods described herein. The secondary memory may also, in some embodiments, include an interface that serves as an interface point to additional storage such as a removable storage unit or a cloud storage network having one or more remote storage devices. Numerous types of data storage devices may serve as repositories for data utilized by the host server network 105 of the present disclosure. For example, magnetic, optical or magnetic-optical storage systems, or any other available mass storage technology that provides a repository for digital information may be used.

The communication interface may, in some embodiments, be coupled to the communication infrastructure and may serve as a conduit for data destined for or received from a communication path. A network interface card (NIC) is an example of the type of device that once coupled to the communication infrastructure may, in some embodiments, provide a mechanism for transporting data to the communication path. Computer networks such Local Area Networks (LAN), Wide Area Networks (WAN), Wireless networks, optical networks, distributed networks, the Internet, or any combination thereof are some examples of the type of communication paths that may be utilized by the host server network 105 and/or the embodiments of the present disclosure. The communication path may, in some embodiments, include any type of telecommunication network or interconnection fabric that can transport data to and from the communication interface.

To facilitate user interaction with the host server network 105, one or more human interface devices (HID) may, in some embodiments, be included. Some examples of HIDs that enable users to input commands or data to the specially programmed computer may include a keyboard, mouse, touch screen devices, microphones or other audio interface devices, motion sensors or the like, as well as any other device able to accept any kind of human input and in turn communicate that input to the processing unit to trigger one or more responses from the host server network 105 are within the scope of the system disclosed herein.

In some embodiments, the host server network 105 may be configured to interface with one or more Internet-of-Things (IoT) devices. As will be appreciated by one skilled in the art, any suitable IoT device and/or protocol or communication standard known by one skilled in the art to be suitable for interfacing with said IoT devices may be utilized within the scope of the present disclosure. In some embodiments, the digital asset tokenization and monetization system 100 may be configured to receive and/or transmit content to and from the one or more interfaced IoT devices using any suitable wireless communication network or protocol. As a non-limiting example, user-generated content may be recorded on an interfaced IoT device, and that content may be received by the digital asset tokenization and monetization system 100 and tokenized/mechanized according to the processes described above in regard to user-generated content posted originally to a social media platform 182. In another non-limiting example, a user profile may be viewable on an interfaced IoT device to allow a user to interact with their tokenized digital assets.

As will be understood by one skilled in the art, the scope of the systems and methods of the present disclosure may also encompass a virtual device, virtual machine or simulator embodied in one or more computer programs executing on a computer or host server network 105 and acting or providing a computer system environment compatible with the methods and processes of the present disclosure. In one or more embodiments, the systems of the present disclosure may include a cloud computing system or any other system where shared resources, such as hardware, applications, data, or any other resources are made available on demand over the Internet 180 or any other network. In one or more embodiments, the systems of the present disclosure may also encompass parallel systems, multi-processor systems, multi-core processors, and/or any combination thereof. Where a virtual machine performs substantially similarly to that of a physical computer system, such a virtual platform will also fall within the scope of disclosure provided herein.

It will be understood that embodiments described herein should be considered in a descriptive sense only and not for purposes of limitation. Descriptions of features or aspects within each exemplary embodiment should typically be considered as available for other similar features or aspects in other embodiments.

While one or more exemplary embodiments have been described with reference to the figures, it will be understood by those of ordinary skill in the art that various changes in form and details may be made therein without departing from the spirit and scope as defined by the following claim. It should be noted that although examples of the invention are set forth herein, the claims, and the full scope of any equivalents, are what define the metes and bounds of the invention.

What is claimed is:

1. An automated NFT creation and monetization system, comprising:
a fingerprinting module configured to automatically capture user-generated content from a social media profile of a user;
a mechanization module configured to generate one or more NFT assets associated with the captured user-generated content from the social media profile of the user; and
a library module configured to store the captured user-generated content from the social media profile of the user and provide a history of one or more blockchain records indicating one or more transfers of ownership and one or more usage-metadata entries of the one or more NFT assets associated with the captured user-generated content.

2. The automated NFT creation and monetization system of claim 1, wherein the library module is further configured to record one or more monetization receipts associated with use of the user-generated content across one or more service providers.

3. The automated NFT creation and monetization system of claim 1, wherein the mechanization module is configured to generate one or more NFT third-party assets associated with one or more derivative works based on the captured user-generated content.

4. A user-generated digital asset tokenization and management platform system, comprising:
a fingerprinting module comprising:
a web crawler module configured to access and identify a user-generated content file hosted on a social-media account of a user; and
an asset capture module configured to create a first party originating source file based on the user-generated content file;
a mechanization module comprising:
a smart contract module configured to generate a non-fungible token associating an ownership record configured to be stored in a blockchain with the first party originating source file; and
a microtransaction module configured to pay and record fees associated with a token creation process on the blockchain; and
a library module comprising:
an asset storage module configured to store, access, and manage the first party originating source file on a cloud storage network;
an asset tracking module configured to manage digital rights management (DRM) products associated with the first party originating source file and the non-fungible token and track usage of the first party originating source file and the non-fungible token across a plurality of service providers;
a monetization module configured to record and organize monetization receipts associated with the usage of the first party originating source file and the non-fungible token across the plurality of service providers; and
a user profile module configured to produce a profile page describing the asset ownership and asset usage statistics associated with the user.

5. The user generated digital asset tokenization and management platform system of claim 4, wherein the fingerprinting module further comprises a verification module configured to verify that the user-generated content file was originally created by the user.

6. The user-generated digital asset tokenization and management platform system of claim 4, wherein the web crawler module is configured to repeatedly access the social media account of the user at a pre-determined intervals to identify newly added content.

7. The user-generated digital asset tokenization and management platform system of claim 4, wherein the fingerprinting module further comprises a hashing module configured to create a unique hashed identifier for the first party originating source file based on the URL of the user-generated content file.

8. The user-generated digital asset tokenization and management platform system of claim 4, wherein the fingerprinting module, the mechanization module, and the library module are all instantiated by the execution of a set of instructions by a processing unit of a host server network.

9. The user-generated digital asset tokenization and management platform system of claim 4, wherein the smart contract module is configured to generate the non-fungible token using a standardized token protocol.

10. The user-generated digital asset tokenization and management platform system of claim 9, wherein the standardized token protocol uses the ERC-721 token standard.

11. The user-generated digital asset tokenization and management platform system of claim 9, wherein the standardized token protocol uses the ERC-1155 token standard.

12. The user-generated digital asset tokenization and management platform system of claim 4, wherein the mechanization module further comprises a watermark module to place a unique watermark within the first party originating source file.

13. The user-generated digital asset tokenization and management platform system of claim 4, wherein the mechanization module is configured to create a NFT third party asset associating a derivative work of the first party originating source file with a third-party ownership record configured to be stored on the blockchain.

14. A method for the automated collection of user-generated content and creation of associated NFT products, comprising:
identifying, by a web crawler module, a user-generated content file hosted on a social media profile of a user;
copying, by a capture module, the user-generated content file to create a first party originating source file;
associating, by a hashing module, a hashed identifier with the first party originating source file, wherein the hashed identifier is based on a query string parameter of a URL for the user-generated content file;
storing, by a storage module, the first party originating source file within a cloud storage network;
generating, by a smart contract module, a non-fungible token (NFT) first party asset for the first party originating source file by associating the first party originating source file and the user within a first block configured to be added to a blockchain; and
displaying, by a library module, a first entry on a user profile corresponding to the NFT first party asset.

15. The method of claim 14, further comprising:
verifying, by a verification module, that the user-generated content file was originally created by the user.

16. The method of claim 14, further comprising:
paying, by a microtransaction module, a fee associated with a token creation process.

17. The method of claim 14, wherein generating of the NFT first party asset by the smart contract module includes using one or more blockchain-agnostic standardized token protocols.

18. The method of claim 14, further comprising:
locating, by a wallet lookup module, a hashed wallet address associated with the user.

19. The method of claim 16, wherein the fee associated with the token creation process is paid to verifiers on the blockchain.

20. The method of claim 14, further comprising:
recording, by a monetization module, one or more monetization receipts from a service provider associated with usage of the first party originating source file.
